(19) United States
(12) Patent Application Publication
(10) Pub. No.: US 2025/0133992 A1
(43) Pub. Date: May 1, 2025

(54) Wide Cut Rotary Header Having Crop Conveyance Spinner

(71) Applicant: AGCO Corporation, Duluth, GA (US)

(72) Inventors: Lane Ethan Jeffers, Hesston, KS (US); Brendon C. Nafziger, Hesston, KS (US)

(21) Appl. No.: 18/905,475

(22) Filed: Oct. 3, 2024

Related U.S. Application Data
(60) Provisional application No. 63/594,194, filed on Oct. 30, 2023.

(51) Int. Cl. A01D 61/00; A01D 43/10

(52) U.S. Cl. CPC A01D 61/004; A01D 43/10

(57) ABSTRACT

A harvesting header has a set of centrally disposed conditioner rolls disposed in a center opening of the header configured to condition crop as the header moves across a field in a direction of travel. The harvesting header includes a cutter bed including a plurality of rotary cutters extending across the path of travel of the header, each rotary cutter being rotatable about an upright axis. At least one crop conveying spinner is mounted outboard the center opening on either side of the center opening. Each crop conveyance spinner has an upright disc having a plurality of paddles attached to a front face of the disc. The disc is mounted for rotation on a shaft, the shaft forming a spinner axis, wherein the spinner axis is perpendicular with the impeller axis.

### CROSS-REFERENCE TO RELATED APPLICATIONS

This application claims the benefit of the filing date of U.S. Provisional Patent Application 63/594,194, “Wide Cut Rotary Header Having Crop Conveyance Spinner,” filed Oct. 30, 2023, the entire disclosure of which is incorporated herein by reference.

### BACKGROUND OF THE INVENTION

### Field of Invention

This invention relates to crop harvesting machines of the type that use rotary cutters to sever standing crops from the field and then condition the cut crop between one or more sets of conditioning rolls before depositing the crop back onto the ground in the form of a windrow or swath and more particularly, it relates to wide cut machines in which the cutting width is greater than the width of a central opening leading to the conditioning rolls such that crop materials cut outboard of the opening is moved inwardly from the outboard cutters.

### Description of Related Art

A rotary header is designed to cut, condition, and lay a wide variety of crops in a uniform windrow. In one preferred rotary cutter bed design, a group of inboard cutters of the cutter bed are arranged with their axes of rotation directly in front of the conditioner rolls. At least one, and preferably two, additional outboard cutters are provided at each end of the bed and have their axes of rotation located outboard of the conditioning structure. The outboard cutters both rotate in the same direction, with their front extremities moving generally inwardly toward the center of the machine to convey outboard cut materials toward the inboard cutters. Most of the cutters of the inboard group are arranged in oppositely rotating pairs with other cutters of the group such that cut crop materials from the paired cutters in the inboard group are directed straight back into the conditioner rolls in a number of streams.

Wide cut rotary harvesters present inherent challenges in getting outboard severed crop materials to flow smoothly and without hesitation in a lateral direction toward the center of the machine before then turning rearwardly and moving through the central discharge opening into the conditioner rolls. Several manufactures use multiple spinning cylindrical cages mounted on both sides of the header to throw the crop towards the center of the header, but this method struggles to move crop all the way to the center and the windrow is left thick on the edges and thin in the center. Other manufactures use augers to convey crop towards the center of header, but this method has many bearings and service points that the user is required to service and maintain.

Due to the increased speeds at which rotary harvesters can travel compared to that of sickle-type machines, cutoff, feeding, and control problems are exacerbated in rotary machines due to the dramatically increased volume of cut material flowing through the machines.

As a result of this hesitation, crop flows into the conditioner rolls in a non-uniform manor. The result of this non-uniform flow is evident in the form of slugs, over-conditioned crop, and a bunchy swath or windrow. These conditions present drying issues along with inferior quality hay in bales.

### BRIEF SUMMARY

In one aspect, the invention is directed to a harvesting header having a set of centrally disposed conditioner rolls disposed in a center opening of the header configured to condition crop as the header moves across a field in a direction of travel. The harvesting header also includes a cutter bed including a plurality of rotary cutters extending across the path of travel of the header to define a cutting plane, each rotary cutter being rotatable about an upright axis. The conditioner rolls are positioned behind the cutter bed to condition crop cut by the rotary cutter bed. The rotary cutters include a set of inboard rotary cutters disposed inboard of lateral limits of the center opening and a set of outboard rotary cutters on either side of the center opening, where the set of outboard cutters on each side of the cutter bed includes an outboard rotary cutter. An outer impeller is fixed to the outboard rotary cutter for rotation therewith to convey cut crop material laterally inwardly toward the center opening of the header. At least one crop conveying spinner is mounted outboard the center opening on either side of the center opening. Each crop conveyance spinner has an upright disc having a plurality of paddles attached to a front face of the disc, where the disc is mounted for rotation on a shaft, the shaft forming a spinner axis, wherein the spinner axis is perpendicular with the impeller axis.

This summary is provided to introduce concepts in simplified form that are further described below in the Detailed Description. This summary is not intended to identify key features or essential features of the disclosed or claimed subject matter and is not intended to describe each disclosed embodiment or every implementation of the disclosed or claimed subject matter. Specifically, features disclosed herein with respect to one embodiment may be equally applicable to another. Further, this summary is not intended to be used as an aid in determining the scope of the claimed subject matter. Many other novel advantages, features, and relationships will become apparent as this description proceeds. The figures and the description that follow more particularly exemplify illustrative embodiments.

### BRIEF DESCRIPTION OF THE SEVERAL VIEWS OF THE DRAWINGS

The above mentioned and other features of this invention will become more apparent and the invention itself will be better understood by reference to the following description of embodiments of the invention taken in conjunction with the accompanying drawings, wherein:

Corresponding reference characters indicate corresponding parts throughout the views of the drawings.

FIG. 1 illustrates a side schematic view of a self-propelled windrower exemplifying one type of harvesting machine that may employ a rotary cutter header in accordance with the principles of the present invention;

FIG. 2 illustrates a front perspective view of a portion of the rotary cutter header of FIG. 1;

FIG. 3 illustrates a front elevational view of the rotary cutter header of FIG. 2; and

FIG. 4 illustrates a rear perspective view of a portion of the rotary cutter header of FIG. 1.

### DETAILED DESCRIPTION

The invention will now be described in the following detailed description with reference to the drawings, wherein preferred embodiments are described in detail to enable practice of the invention. Although the invention is described with reference to these specific preferred embodiments, it will be understood that the invention is not limited to these preferred embodiments. But to the contrary, the invention includes numerous alternatives, modifications and equivalents as will become apparent from consideration of the following detailed description. Many of the fastening, connection, processes and other means and components utilized in this invention are widely known and used in the field of the invention described, and their exact nature or type is not necessary for an understanding and use of the invention by a person skilled in the art, and they will not therefore be discussed in significant detail. Also, any reference herein to the terms “left” or “right” are used as a matter of mere convenience and are determined by standing at the rear of the machine facing in its normal direction of travel. Furthermore, the various components shown or described herein for any specific application of this invention can be varied or altered as anticipated by this invention and the practice of a specific application of any element may already by widely known or used in the art by persons skilled in the art and each will likewise not therefore be discussed in significant detail.

As used herein, the singular forms following “a,” “an,” and “the” are intended to include the plural forms as well, unless the context clearly indicates otherwise. As used herein, the term “may” with respect to a material, structure, feature, or method act indicates that such is contemplated for use in implementation of an embodiment of the disclosure, and such term is used in preference to the more restrictive term “is” so as to avoid any implication that other compatible materials, structures, features, and methods usable in combination therewith should or must be excluded. As used herein, the term “configured” refers to a size, shape, material composition, and arrangement of one or more of at least one structure and at least one apparatus facilitating operation of one or more of the structure and the apparatus in a predetermined way.

As used herein, any relational term, such as “first,” “second,” “top,” “bottom,” “upper,” “lower,” “above,” “beneath,” “side,” etc., is used for clarity and convenience in understanding the disclosure and accompanying drawings and does not connote or depend on any specific preference or order, except where the context clearly indicates otherwise.

As used herein, the term “about” used in reference to a given parameter is inclusive of the stated value and has the meaning dictated by the context (e.g., it includes the degree of error associated with measurement of the given parameter, as well as variations resulting from manufacturing tolerances, etc.). As used herein, the term “substantially” in reference to a given parameter, property, or condition means and includes to a degree that one skilled in the art would understand that the given parameter, property, or condition is met with a small degree of variance, such as within acceptable manufacturing tolerances. By way of example, depending on the particular parameter, property, or condition that is substantially met, the parameter, property, or condition may be at least 90.0% met, at least 95.0% met, at least 99.0% met, or even at least 99.9% met.

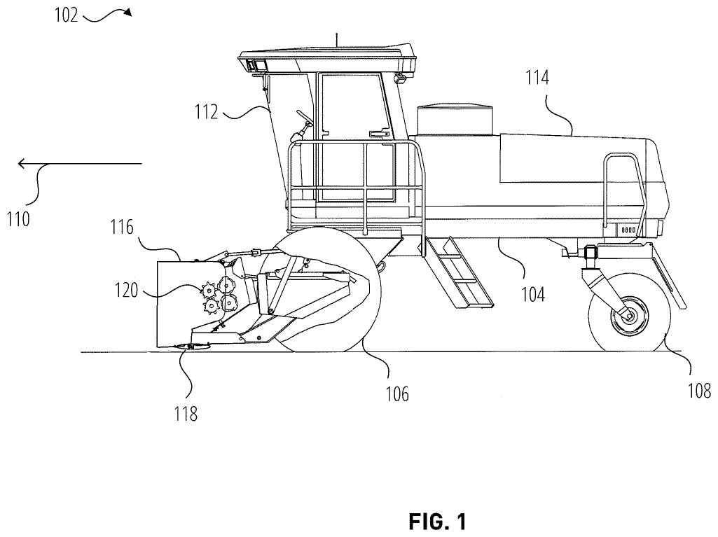

Referring initially to FIG. 1, the harvester selected for illustration in that figure comprises a self-propelled windrower 102 operable to mow and collect standing crop in the field, condition the cut material as it moves through the machine to improve its drying characteristics, and then return the conditioned material to the field in a windrow or swath. Windrower 102 includes a chassis or frame 104 supported by a pair of front drive wheels 106 and a pair of rear caster wheels 108 for movement across a field to be harvested in a forward direction of travel indicated by arrow 110. Frame 104 carries a cab 112, within which an operator controls operation of windrower 102, and a rearwardly spaced engine compartment 114 that houses a power source such as an internal combustion engine.

A harvesting header 116 is supported on the front of frame 104 in a manner well understood by those skilled in the art. The header 116 includes a cutter bed 118 across the front of the machine that serves as the means by which standing crops are severed as the windrower 102 advances across a field. In the illustrated embodiment, the header 116 has a set of centrally disposed conditioning rolls 120 behind the cutter bed 118.

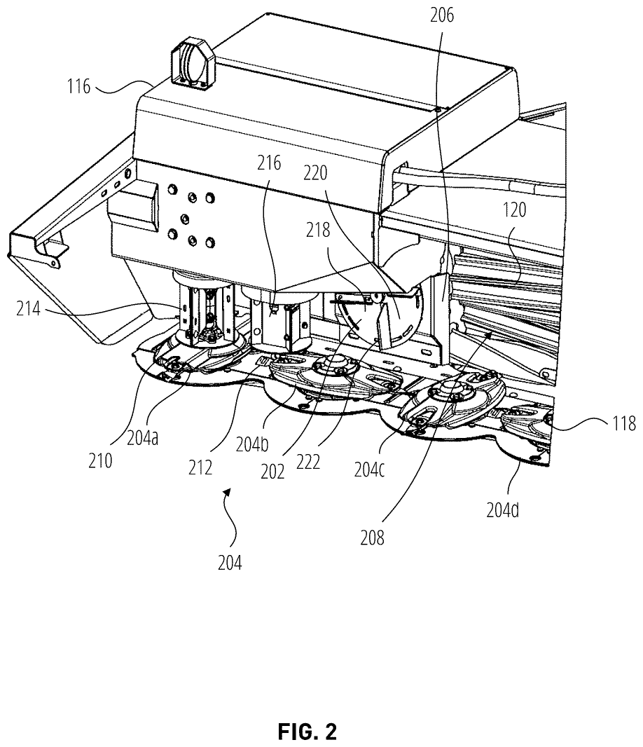

Turning now to FIG. 2, the cutter bed 118 includes a series of rotary cutters 204 extending across the path of travel of the windrower 102, each rotary cutter 204 being rotatable about its own upright axis. In one embodiment, the cutter bed 118 has ten rotary cutters 204 across the width of the cutter bed 118. However, a larger or smaller number of rotary cutters 204 could be provided. For the sake of convenience, the rotary cutters 204 in FIG. 2 are denoted by the numerals 204a-204d, beginning with the leftmost rotary cutter 204 as viewed from the front of the header 116. While FIG. 2 illustrates one side of the cutter bed 118, it will be understood that the opposing side of the header 116 may be of a design that is a substantial mirror image of the illustrated side.

Header 116 is constructed in such a way as to present a pair of upright, laterally spaced apart panels 206 behind the cutter bed 118 that cooperate to in part define lateral boundaries of a rearward center opening 208 that defines a crop conditioning region in which the set of conditioning rolls 120 is located. In the illustrated embodiment, the set of conditioning rolls 120 includes two pairs of cooperating conditioning rolls 120, although a single pair or more than two pairs could be utilized without departing from the principles of the present invention. Conditioning rolls 120 may assume a variety of configurations without departing from the principles of the present invention. For example, the conditioning rolls 120 could all be hard, metal rolls, or some could be softer rolls having compressible outer surfaces. While different conditioning actions are achievable with different roll configurations and materials, the particular choice of such configurations and materials is not critical as far as the present inventive concepts are concerned. In all instances, however, the conditioning rolls 120 will have some kind of conditioning structure on their outermost peripheral surfaces, whether such surfaces are ribbed, grooved or smooth, for example. As conditioning rolls 120 are well known in the art, they need not be discussed further herein.

The axes of rotation of rotary cutters 204a and 204b are disposed outboard of the conditioning structure on the conditioning rolls 120 such that those cutters may be described as “outboard” cutters. On the other hand, the axes of rotation of the rotary cutters 204c-204d are disposed inboard of the lateral limits conditioning structure on the conditioning rolls 116 such that those cutters may be described as a group of “inboard” cutters. While the illustrated embodiment has a set or pair of outboard cutters on each side, other embodiments may utilize more or fewer outboard cutters. An exemplary cutter bed 118 and set of conditioning rolls 120 is illustrated in commonly assigned U.S. Pat. No. 7,726,108.

As is known in the art, rotary cutters 204 are arranged in oppositely rotating pairs, such as the pair consisting of rotary cutters 204b, 204c and the pair consisting of rotary cutters 204d and the next inwardly adjacent cutter (not shown). One rotary cutter 204 of each pair rotates in a counterclockwise direction viewing FIG. 2, and the other rotates in a clockwise direction viewing that same figure. Thus, using the paired rotary cutters 204b and 204c as an example, rotary cutter 204b rotates in a counterclockwise direction while rotary cutter 204c rotates in a clockwise direction. While paired rotary cutters 204 of the inboard group cooperate with other inboard cutters, the end rotary cutter 204c in the inboard group cooperate with outboard rotary cutter 204b. Thus, each of the first and last pairs of oppositely rotating cutters comprises a “mixed” pair of cooperating cutters consisting of one inboard cutter and one outboard cutter.

Each pair of oppositely rotating rotary cutters 204 sends a stream of severed material rearwardly between them as the windrower 102 moves through the field of standing crop. The outermost outboard rotary cutter 204a rotates in the same direction as the inwardly adjacent outboard rotary cutter 204b. Thus, the outermost outboard rotary cutter 204a rotates in a counterclockwise direction viewing FIG. 2. Consequently, crop material cut by outboard cutters 204a, 204b is thrown laterally inwardly generally toward the overlap region between rotary cutters 204b and 204c, where it is swept rearwardly.

As is known in the art, rotary cutters 204 are rotatably supported on an elongated, flat gear train (not shown) that extends underneath the cutters for the full effective width of header 116 and driven by one or more hydraulic motors as will be understood by one skilled in the art. Additionally, each of the rotary cutters 204 includes a generally elliptical, formed metal knife carrier 210 and a pair of free-swinging knives 212 at opposite ends of carrier 210 in a well-known manner. The circular paths of travel of the knives 212 of adjacent rotary cutters 204 overlap one another.

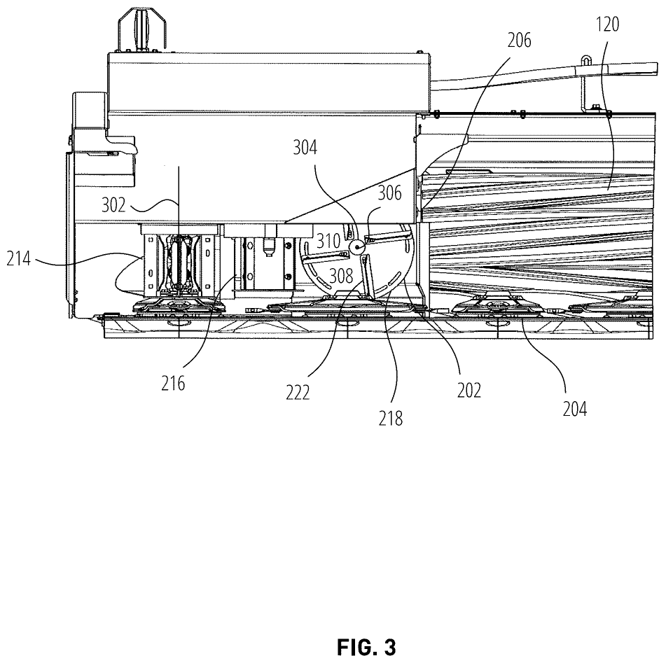

As is known in the art, in one embodiment the outermost outboard rotary cutter 204a is provided with an upright, generally cylindrical, cage-like impeller 214 fixed to its corresponding carrier 210 for rotation therewith such that it rotates about an impeller axis 302 (FIG. 3). Impeller 214 helps convey cut crop materials laterally inwardly toward the center of the header 116. The illustrated embodiment shows the header 116 may also have an intermediate, depending, upright, cage-like impeller 216 located inwardly beside impeller 214 generally centrally between the axes of rotation of the two outboard rotary cutters 204a, 204b. In the illustrated embodiment, the impeller 216 is not fixed to any of the cutters but is instead suspended by overhead structure not shown above the cutting plane of knives 212 for rotation in the same direction as the adjacent outboard impeller 214. The bottom extremity of impeller 216 is spaced a short distance above the cutting plane of the knives 212.

According to the invention, at least one crop conveying spinner 202 is mounted outboard the center opening 208 to the conditioning rolls 120. In the illustrated embodiment, the crop conveying spinner 202 is positioned outboard the center opening 208 but inboard the impeller 214 and impeller 216. The crop conveyance spinner 202 has an upright disc 218, generally circular in shape, which is oriented so that a front face 220 of the disc 218 is positioned parallel with the flow of crop toward the center opening 208. The spinner 202 has a plurality of paddles 222 attached to the front face 220 of the disc 218. The illustrated spinner 202 has four paddles 222 positioned equidistant around the circumference of the disc 218. However, more, or fewer paddles 222 may be used.

As perhaps best seen in FIG. 3, the disc 218 is mounted for rotation on a shaft 304. The shaft 304 forms a spinner axis 306, with the spinner axis 306 being perpendicular with the impeller axis 302 and parallel to the direction of travel 110 of the windrower 102. The rotating spinner 202 has a lower portion 308 generally below the shaft 304 and an upper portion 310 generally above the shaft 304, with the disc 218 having a diameter such that the shaft 304 of the spinner 202 is desirably above the flow of the crop cut by the rotary cutters 204. This is to allow only the paddles 222 in the lower portion 308 of the disc 218 to contact the crop and move material from the outer edge of the header 116 and rotary cutters 204a and 204b towards the center opening 208. In the illustrated embodiment shown in FIG. 3, the spinner 202 rotates in the counterclockwise direction such that the paddles 222 move the crop from the outer edge towards the center opening 208. The paddles 222 desirably are installed at an angle that allows crop to be grabbed, moved towards the center opening 208 of the header 116, and released in a way that it feeds evenly into the conditioning rolls 120.

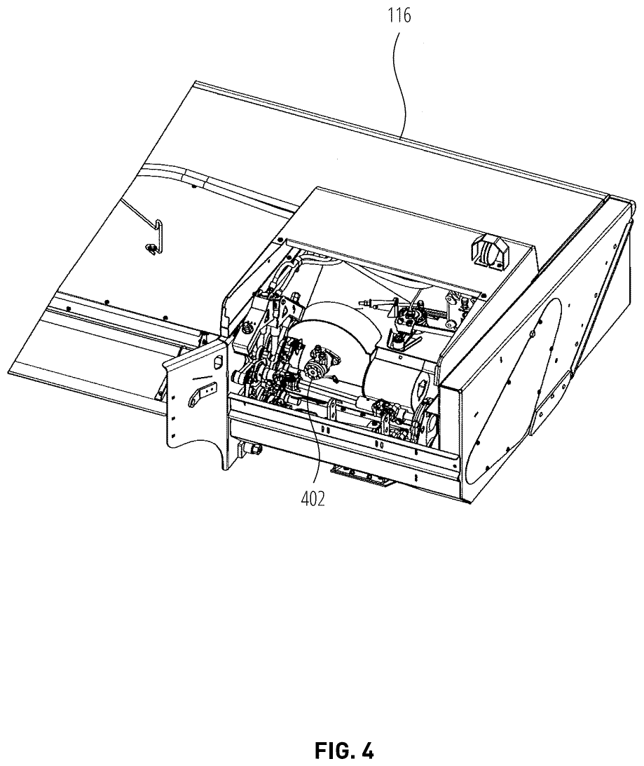

As best seen in FIG. 4, the shaft 304 of the crop conveyance spinner 202 is powered by a motive force 402. In one embodiment as seen in FIG. 4, the motive force 402 is a hydraulic motor. However, one skilled in the art will understand that the motive force 402 may be mechanically driven such as by part of the gear train of the cutter bed 118, electrically driven using an electric motor, or other means using sound engineering judgment.

The foregoing has broadly outlined some of the more pertinent aspects and features of the present invention. These should be construed to be merely illustrative of some of the more prominent features and applications of the invention. Other beneficial results can be obtained by applying the disclosed information in a different manner or by modifying the disclosed embodiments. Accordingly, other aspects and a more comprehensive understanding of the invention may be obtained by referring to the detailed description of the exemplary embodiments taken in conjunction with the accompanying drawings.

What is claimed is:

1. A harvesting header comprising:
a set of centrally disposed conditioner rolls disposed in a center opening of the header configured to condition crop as the header moves across a field in a direction of travel;
a cutter bed comprising:
a plurality of rotary cutters extending across the path of travel of the header to define a cutting plane, each rotary cutter being rotatable about an upright axis, the conditioner rolls being behind the cutter bed to condition crop cut by the rotary cutter bed, wherein the plurality of rotary cutters comprises a set of inboard rotary cutters disposed inboard of lateral limits of the center opening and a set of outboard rotary cutters on either side of the center opening, wherein the set of outboard cutters on each side of the cutter bed comprises an outboard rotary cutter;
an outer impeller fixed to the outboard rotary cutter for rotation therewith about an impeller axis parallel with the upright axis of the outboard rotary cutter to convey cut crop material laterally inwardly toward the center opening of the header; and
at least one crop conveying spinner mounted outboard the center opening on either side of the center opening, wherein each crop conveyance spinner has an upright disc having a plurality of paddles attached to a front face of the disc, wherein the disc is mounted for rotation on a shaft, the shaft forming a spinner axis, wherein the spinner axis is perpendicular with the impeller axis.

2. The harvesting header of claim 1 wherein the spinner axis is parallel to the direction of travel of the header.

3. The harvesting header of claim 1 wherein the header has a first crop conveying spinner outboard the center opening on a first side of the header and a second crop conveying spinner outboard the center opening on a second side of the header.

4. The harvesting header of claim 1 wherein the rotating spinner has a lower portion 308 generally below the shaft and an upper portion generally above the shaft, and the spinner rotates in a direction such that the paddles while in the lower portion of the disc contact the crop and move the crop towards the center opening.

5. The harvesting header of claim 1 wherein the rotating spinner has a lower portion generally below the shaft and an upper portion generally above the shaft, with the disc having a diameter such that the shaft of the spinner is above the flow of the crop cut by the rotary cutters.

6. The harvesting header of claim 1 wherein the disc is circular in shape.

7. The harvesting header of claim 1 wherein the spinner has four paddles positioned equidistant around a circumference of the disc.

8. The harvesting header of claim 1 wherein the disc is oriented so that the front face is positioned parallel with the flow of crop from the outboard rotary cutters toward the center opening.

9. The harvesting header of claim 1 wherein the shaft of the crop conveying spinner is powered by a motive force.

10. The harvesting header of claim 1 wherein the outer impeller is fixed to the outermost outboard rotary cutter for rotation therewith.
